(19) United States
(12) Patent Application Publication
(10) Pub. No.: US 2007/0095503 A1
(43) Pub. Date: May 3, 2007

(54) High density corrosive resistant gas to air heat exchanger

(76) Inventors: Rishabh Sinha, Peoria, IL (US); Nathan O. Rasmussen, Peoria, IL (US); Kyle C. Hummel, Holly Springs, NC (US); Jiubo Ma, Dunlap, IL (US)

Correspondence Address: CATERPILLAR c/o LIELL & MCNEIL ATTORNEYS PC, P.O. BOX 2417, 511 SOUTH MADISON STREET, BLOOMINGTON, IN, 47402-2417, US

(21) Appl. No.: 11/507,246

(22) Filed: Aug. 18, 2006

Related U.S. Application Data
(63) Continuation-in-part of application No. 11/236,072, filed on Sep. 27, 2005.

(51) Int. Cl. B60H 1/00

(52) U.S. Cl. 165/41

(57) ABSTRACT

A gas to air heat exchanger includes corrosive resistant tubes made from or internally coated with one material, and high thermal conductivity air fins made from another material. This construction allows for meeting heat transfer requirements in a spatially constrained application, such as over the road trucks, where a mixture of recirculated exhaust gas and incoming air are compressed, then cooled, before being supplied to the engine intake. In one example, the heat exchanger includes tubes made from stainless steel brazed to relatively thin copper air fins in a low temperature brazing process, and the tubes are brazed on respective ends to heads of stainless steel via a high temperature brazing process. This core is then joined to an aluminum inlet tank and possible non-metallic outlet tank via a mechanical crimping process that positions a seal between the tanks and the respective heads. In another example embodiment, corrosive resistant brazing material connects certain components of the heat exchanger, and coats surfaces of the heat exchanger exposed to condensed corrosive gases from engine exhaust.

### CROSS-REFERENCE TO RELATED APPLICATIONS

This patent application is a continuation-in-part of U.S. patent application Ser. No. 11/236,072, filed Sep. 27, 2005.

### TECHNICAL FIELD

The present disclosure relates generally to gas to air heat exchangers, and more specifically to cooling potentially corrosive gases, such as engine exhaust, in an envelope with relatively tight spatial constraints.

### BACKGROUND

In recent times, when an engine included a turbocharger and exhaust gas recirculation, it might be only the incoming air that is compressed via the turbocharger before being combined with recirculated exhaust gas that is supplied to the engine. Such an engine, for example, is shown in co-owned U.S. Pat. No. 6,526,753. More recently, there have arisen reasons for adding the exhaust gas to the incoming air before passing the combined mixture through the turbocharger for compression. The compressed exhaust gas/air mixture often needs to be cooled before being supplied to the engine intake. Because the exhaust gases can contain corrosive constituents, such as sulfuric and/or nitric acid, the wetted surfaces of the cooler can, and often will, corrode over time. After a prolonged period, the fluid isolation between the cooling tubes and the air fins can be undermined, and in more extreme situations, the inlet or outlet tank can become corroded leading to holes allowing the hot exhaust gases to vent to atmosphere.

Some heat exchanger applications have additional problematic constraints. For instance, the spatial envelope available in an over the road truck can severely limit the space available for inclusion of a necessary gas to air heat exchanger. When relying on construction techniques according to the conventional wisdom these spatial constraints can become even more acute. Typically, a heat exchanger will include tubes, air fins and heads all constructed from a similar material that are joined together in a conventional well known brazing process. However, when corrosion resistance is a substantial issue, combined with severe spatial constraints, the conventional wisdom in some instances will suggest that the cooling demands of a given engine system in a specific application, such as an over the road truck, simply cannot be met in the space available. Completely redesigning the remaining portion of the engine to gain additional volume for a gas to air heat exchanger is too expensive an option for realistic consideration, in many cases.

While certain heat exchanger materials can provide adequate corrosion resistance in engine exhaust environments, such as stainless steel, such materials are often accompanied by a trade off in terms of increasing weight. Certain materials having relatively higher corrosive resistance are also often characterized by relatively lower cooling performance, requiring very thin wetted wall thickness and/or larger size and complexity to achieve heat exchange efficiency similar to that of less corrosive resistant materials. The relatively tight spatial constraints, corrosive conditions, and the need to minimize weight and complexity of exhaust gas coolers have together provided substantial challenges to engineering acceptable exhaust gas coolers for internal combustion engines.

The present disclosure is directed to overcoming one or more of the problems set forth above.

### SUMMARY OF THE INVENTION

In one aspect, the present disclosure provides a gas to fluid heat exchanger including a core having a plurality of tubes in heat transfer contact with a plurality of fins, the tubes being fluidly isolated from the fins. A plurality of turbulators are disposed within the tubes, each including at least one base material having a relatively low corrosive resistance. The heat exchanger further includes a brazing material having a relatively high corrosive resistance coating the turbulators and attaching the turbulators to the tubes.

In another aspect, the present disclosure provides an engine system having an engine housing and a gas passage fluidly connected to the engine housing. A gas to fluid heat exchanger is fluidly positioned within the gas passage and includes a core having a plurality of tubes and a plurality of fins in heat transfer contact with the tubes. A plurality of turbulators are disposed within the tubes and include at least one base material having a relatively low corrosive resistance, and are coated with a brazing material having a relatively high corrosive resistance which attaches the turbulators to the tubes.

In still another aspect, the present disclosure provides a method of making a gas to fluid heat exchanger including coating at least one base material of a turbulator having a relatively low corrosive resistance with a brazing material having a relatively high corrosive resistance. The method further includes placing the turbulator within a tube of a heat exchanger core, and attaching the turbulator to the tube at least in part via the brazing material.

### BRIEF DESCRIPTION OF THE DRAWINGS

FIG. 1 is a schematic of an engine system according to the present disclosure;

FIG. 2 is a schematic illustration of a gas to air heat exchanger according to the present disclosure;

FIG. 3 is a sectioned view looking into one of the tubes for the heat exchanger of FIG. 2;

FIG. 4 is a partial sectioned corner view of a mechanical attachment between a head and tank portion of the heat exchanger of FIG. 2; and

FIG. 5 is a sectioned end view of a heat exchanger with a tube having a turbulator therein, according to the present disclosure.

### DETAILED DESCRIPTION

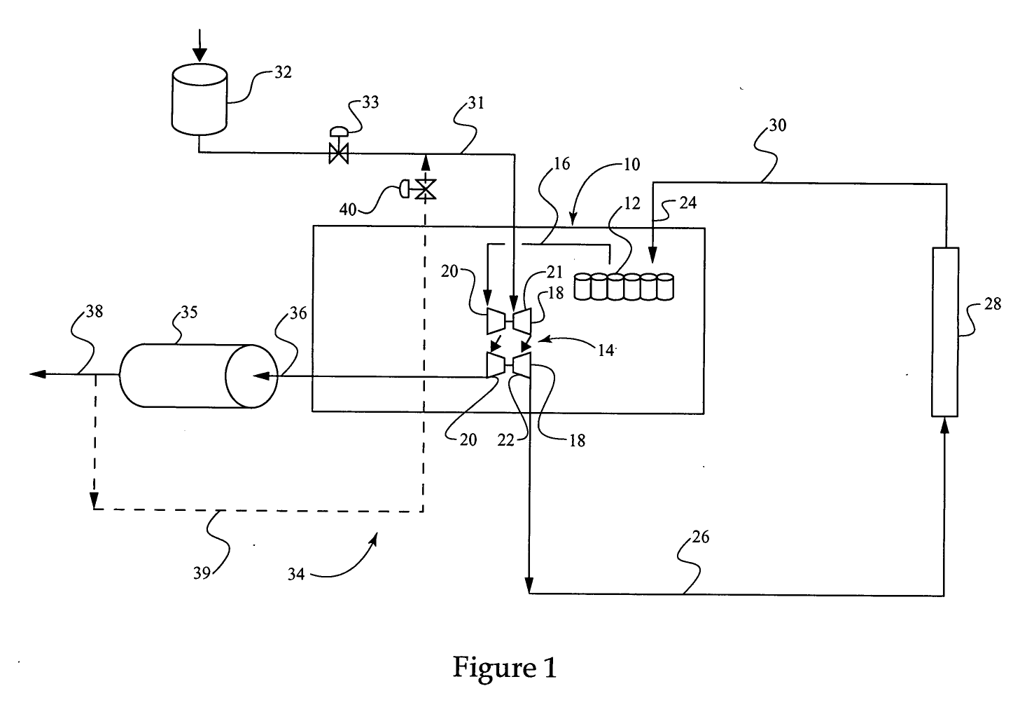

Referring now to FIG. 1, an engine system 10 includes a plurality of combustion cylinders 12 and at least one turbocharger 14. In the illustrated example, two turbochargers 14 include a pair of compressors 18 in series as well as a pair of turbines 20 in series, which are fluidly connected to exhaust manifold 16 in a conventional manner. Engine system 10 includes a gas to air heat exchanger 28 fluidly connected between a compressor outlet 22 and an engine intake 24 via a hot gas passage 26 and a cooled gas passage 30, respectively. Engine system 10 also includes an exhaust gas recirculation system 34 fluidly connected between an engine exhaust 36 and a compressor inlet 21. In particular, the exhaust gas recirculation system 34 includes an exhaust gas recirculation passage 39 fluidly connected to supply passage 31 via an EGR control valve 40. Ambient air is drawn into supply passage 31 past an air filter 32 and through a valve 33 so that, along with EGR control valve 40, the relative amounts of exhaust gas and fresh air supplied to the engine can be controlled via an electronic control module (not shown) in a conventional manner. The engine also includes one or more exhaust aftertreatment devices 35 positioned in exhaust passage 36, which may include a particle trap, an oxidation catalyst and the like. Exhaust passage 36 eventually terminates in a tail pipe 38.

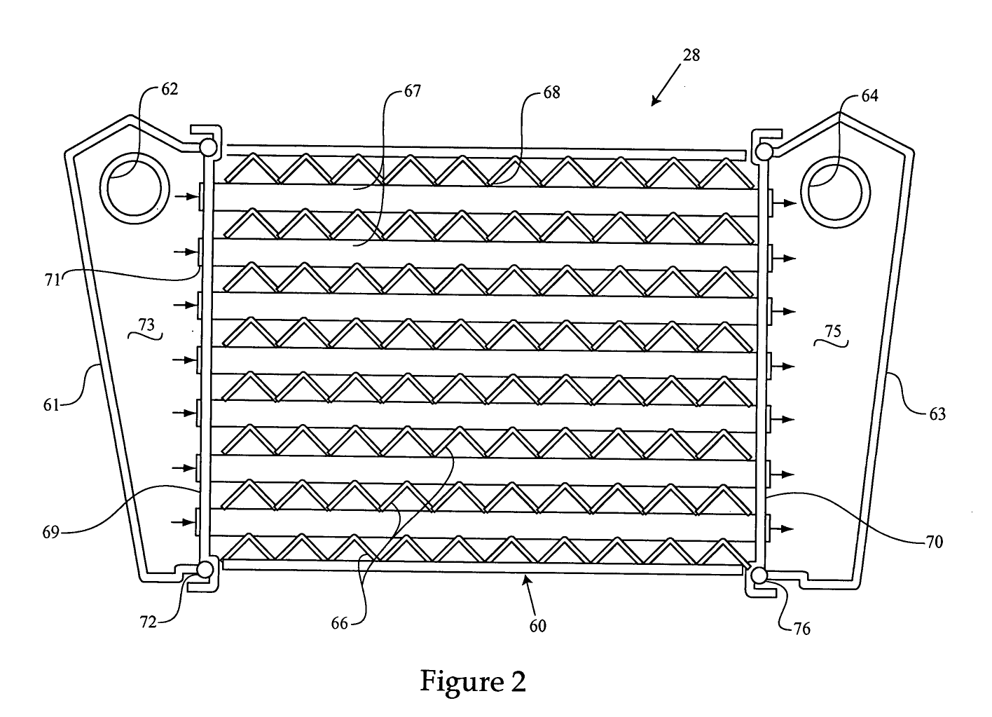

Referring now in addition to FIG. 2, gas to air heat exchanger 28 includes a core 60 and an inlet tank 61 with an inlet 62 fluidly connected to hot gas passage 26, and an outlet tank 63 with an outlet 64 fluidly connected to cooled gas passage 30. Hot gases entering inlet 62 enter an inlet manifold area 73 and travel through a plurality of tubes 67 into outlet manifold area 75. The hot gases traveling through tubes 67 exchange heat, via a heat transfer surface of tubes 67, with air traveling in a direction in and out of the page and past air fins 66 in a conventional manner.

In order to meet tight spatial constraints while having superior heat transfer capability in the face of potentially corrosive gases, gas to air heat exchanger 28 includes a number of unique features. By putting an appropriate amount of the appropriate material in the right locations, gas to air heat exchanger 28 can provide adequate heat exchange while avoiding many of the problems associated with corrosive gases, and do so in a tight spatial envelope. From one perspective, this is accomplished by making the minimum wetted wall thickness of tanks 61 and 63 thicker than the minimum wetted wall thickness of tubes 67, which have a greater thickness than the minimum wetted wall thickness of air fins 66. Using this strategy, and realizing that the air fins need not be substantially corrosive resistant, they can be made of a relatively thin highly thermally conductive material, such as thin sheeting made predominantly of copper. Although not preferred, air fin material could also be cuprobrazed copper, and less preferably a suitable stainless steel alloy, such as 409 stainless steel. Those skilled in the art will appreciate that the air fin material can include any of a variety of materials exhibiting thermal conductive properties typical of the materials just identified. In any instance, the air fin material should be more thermally conductive than a tube material for tubes 67.

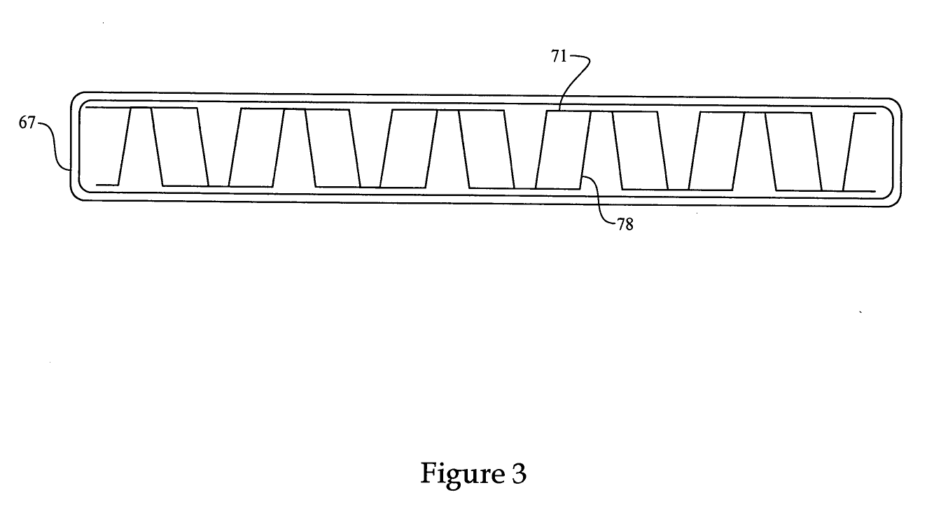

Like air fins 66, tubes 67 must have substantial thermal conductivity, but resistance to corrosion is also an important consideration. Those skilled in the art will recognize that the more thermally conductive a material is, generally the lower its ability to resist corrosion, and vice versa. With this in mind, tubes 67 might be made of stainless steel, with that being chosen in order of preference from 409 stainless steel, 304 and possibly even 316 stainless steel. Apart from stainless steel, tubes 67 might also be constructed from a suitable corrosive resistant material such as titanium, nickel plated aluminum, or possibly even nickel plated steel. Given these examples, those with ordinary skill in the art will recognize a family of materials that could be used for tubes 67 that have significant corrosive resistance, yet retain sufficient thermal conductivity for use in a heat exchanger application. As shown in FIG. 3, tubes 67 may or may not include internally brazed turbulators 78, which if included, may be made of a material similar to that of its surrounding tube 67. The tube material should be more corrosive resistant than the air fin material.

As in a conventional heat exchanger, the gas to be cooled is isolated from air fins 66 by attaching heads 69 and 70 at opposite ends of tubes 67. Like turbulators 78, heads 69 and 70 are preferably made from a material similar to that of tubes 67, to ease the attachment between the two. Thus, in one specific example, heads 69 and 70, as well as tubes 67 and turbulators 78, if any, would all be made from a common stainless steel material and then brazed to one another with a high temperature brazing material 71 in a conventional manner. Some suitable high temperature brazing alloys include 613 nickel based alloys, nickel plating alloys, and possibly even Bnix alloys. After brazing together the tubes 67, heads 69, 70 and any turbulator 78, air fins 66 are fitted between tubes 67 and attached to the tubes in a relatively low temperature brazing process that facilitates good heat transfer between tubes 67 and air fins 66. Some suitable low temperature alloys might include OKC 600, nickel plating alloys, and copper based alloys. Those skilled in the art will appreciate that based upon these example brazing alloys, a number of different alternatives would be available without departing from the scope of the present disclosure.

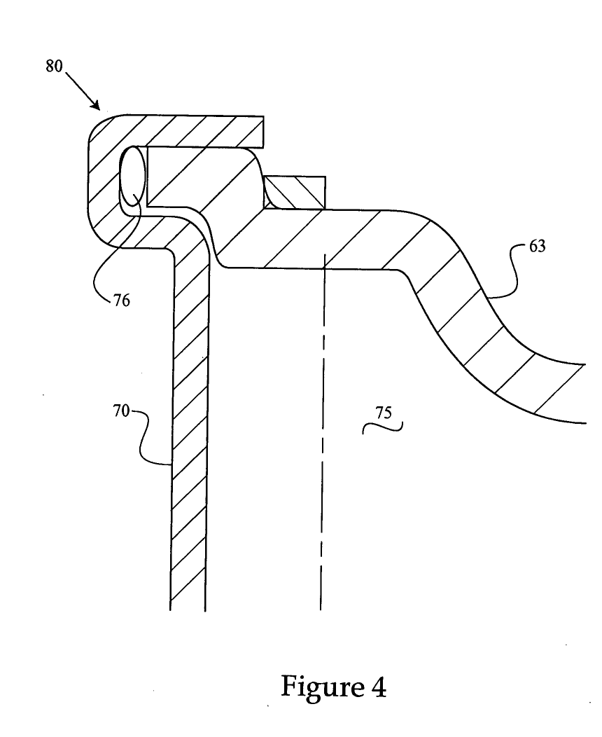

Inlet tank 61 must take into account other considerations, including but not limited to, corrosive resistance and cost considerations as well as high temperatures. With these considerations in mind, tank 61 could be constructed from aluminum, such as a cast aluminum alloy with relatively thick walls that can tolerate expected corrosive concentrations and durations without allowing corrosive holes to develop. Outlet tank 63 could be made of a like material, or further weight and cost savings might be achieved by employing some other material, such as a non-metallic composite since the gases arriving at outlet area 75 are much lower in temperature than those entering inlet tank 61. Referring to FIG. 4, in order to mate the inlet and outlet tanks 61, 63 to the respective heads, 69 and 70, a mechanical attachment is preferably used by crimping the respective heads around an exposed flange on the respective tanks 61 and 63. Another mechanical attachment might include conventional fasteners, such as bolts or screws. In order to prevent gas from escaping, a suitable o-ring seal is positioned between the respective tank 61, 63 and its counterpart head 69, 70. Thus, heat exchanger 28 is preferably constructed by first employing a high temperature brazing process to assemble the heads 69, 70, tubes 67, and interior turbulators 78, if any, in a high temperature brazing process using a suitable brazing alloy. Next, the highly thermally conductive air fins are attached to the tubes, which are typically made from a different and relatively thinner material than that of the tubes 67 via a low temperature brazing process. The heat exchanger is then completed by mechanically attaching, such as via a crimping process, the external tanks 61 and 63 with an o-ring seal positioned there between.

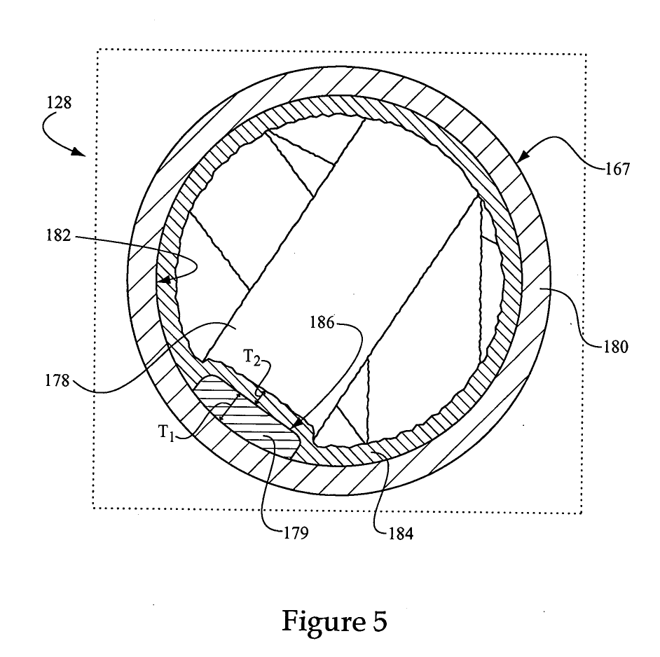

As an alternative or supplement to the aforementioned materials and material placement in a heat exchanger, certain of the heat exchanger components having desired heat exchange properties may be coated with suitably corrosive resistant materials. Referring to FIG. 5, there is shown a heat exchanger 128 according to another embodiment of the present disclosure. Heat exchanger 128 is contemplated to be applicable to engine systems in a manner similar to that of heat exchanger 28 discussed above. For instance, heat exchanger 128 might be positioned between hot gas passage 26 and cool gas passage 30 in engine system 10 of FIG. 1.

Heat exchanger 128 may include a core, having a plurality of tubes 167, one of which is shown via a sectioned end view in FIG. 5. Tube 167 may be configured to thermally contact one or more air fins (not shown), similar to tubes 67 shown in FIG. 2. Heat exchanger 128 differs from other heat exchangers described herein, primarily in that turbulator 178 which is positioned within tube 167 may comprise a heat transfer/exchange surface 186 that is coated with a relatively highly corrosive resistant coating. The coating, which may comprise a corrosive resistant brazing material 184, may be applied to heat exchange surface 186 to provide corrosive resistance to gases and condensed gases passing through tube 167. Coating turbulator 178 with brazing material 184 serves the dual purposes of providing substantial corrosive resistance, while also attaching turbulator 178 to tube 167. This strategy allows turbulator 178 to be constructed from a relatively good heat transfer base material such as copper, having a relatively low corrosive resistance, without subjecting the base material (copper) to the corrosive exhaust gas environment. In a typical embodiment, a plurality of turbulators similar to the single turbulator 178 shown in FIG. 5 will be positioned within a plurality of tubes similar to tube 167 to provide a heat exchanger core having a configuration similar to heat exchanger 28, described above, but with some or all internal surfaces coated with corrosive resistant brazing material.

In a related embodiment, tube 167 may itself be constructed from a relatively highly effective heat transfer material such as copper, also protected from the corrosive environment within tube 167 via a coating such as brazing material 184. It is contemplated that turbulator 178 may comprise at least one base material, predominantly copper, but might also include another base material such as a solder or similar material used in connecting turbulator 178 to tube 167. In other words, while it is contemplated that application of brazing material 184 to turbulator 178 will serve dual purposes of attachment to tube 167 and protection from the corrosive environment, some additional material might be used in the attaching and/or coating process. It is further contemplated that the base material of turbulator 178, identified herein via numeral 179, may have a first thickness T₁, and brazing material 184 may have a second thickness T₂ that is less than the first thickness T₁. In one specific embodiment, the thickness of brazing material 184 may be in the range of about 0.05 millimeters to 0.10 millimeters.

In still other embodiments, turbulators 178 might comprise predominantly copper, but tubes 167 might comprise a relatively highly corrosive resistant material such as stainless steel, absent coating 184. Those skilled in the art may recognize that in certain applications, the heat transfer effectiveness of a relatively highly corrosive resistant material such as stainless steel may be optimized by manufacturing heat exchanger materials to have a particularly thin wetted wall thickness. To this end, a wall 180 of tube 167 might be relatively thicker or thinner, depending upon the material chosen for tubes 167. Where tube 167 is predominantly copper, coated with brazing material 184, wall 180 may be relatively thicker. Where stainless steel tubes are used, wall 180 might be relatively thinner.

Manufacturing of heat exchanger 128 may take place via a brazing process, wherein brazing material 184 is applied to coat all of the desired surfaces. A fluent material such as a brazing slurry might be sprayed or otherwise applied to all of the surfaces to be protected from the corrosive environment prior to brazing the heat exchanger components together. One suitable thermal spray technique for application of brazing material is taught in U.S. Pat. No. 7,032,808. Whether brazing material is applied to surfaces 182 of tubes 167 will depend upon the material selected for tubes 167. In related embodiments, air fins (not shown) may be attached to tubes 167 via brazing material 184. Thus, the entire heat exchanger 128 might be dipped, sprayed, etc. with brazing material 184 prior to attaching the respective components via heating in a brazing furnace, if desired. It should be understood that the terms coated, coating, etc. as used herein are intended to mean that the subject brazing material substantially or entirely covers the surfaces of heat exchanger 128 which are to be protected from the corrosive exhaust gas environment. Thus, turbulators 178 are coated with brazing material in the embodiment of FIG. 5, meaning that the brazing material provides a corrosive resistant barrier between the turbulator base material 179 and the corrosive environment inside tube 167.

Similar to the embodiments described above, air fins included in heat exchanger 128 will generally need not be particularly corrosive resistant, and will thus typically be made from an air fin material that has a relatively high heat exchange capacity to optimize operation of heat exchanger 128. Use of the presently described process and construction techniques can enable manufacturing of heat exchanger 128 in a minimal number of steps, for example via a single heating/brazing step, wherein the air fins are attached to tube(s) 167 via brazing material, and optionally wherein heads (not shown) of heat exchanger 128 are also connected tubes 167 via brazing material.

In selecting a brazing material that may also serve as a coating on surfaces of turbulator 178 and/or tube 167, several factors must be considered. Where copper is used as the tube material and/or turbulator material, it will of course be desirable to utilize a copper compatible brazing material. The brazing material, however, will need to have a corrosive resistance higher than that of copper. Suitable brazing pastes, slurries, foils, etc., are available from a variety of commercial sources. The brazing filler material mentioned above, OKC 600, may serve as a suitable corrosive resistant material for coating the respective surfaces of heat exchanger 128 and also attaching turbulators 178 to tubes 167. Other, suitably corrosive resistant, for example acidic corrosive resistant, materials may be used as the coating/brazing material without departing from the spirit and scope of the present disclosure. Suitable brazing materials are disclosed in U.S. Pat. No. 5,378,294, for example.

### INDUSTRIAL APPLICABILITY

The gas to air heat exchanger 28 according to the present disclosure finds potential application where corrosive gases need to be cooled with, but isolated from, air, and this cooling must be done in a relatively tight spatial constraint. For instance, in some work machines, such as over the road trucks, engines have evolved to include turbocharging and exhaust gas recirculation upstream from the compressor. When this occurs, the mixture of incoming air and exhaust gases must often need to be cooled prior to entry into the engine so that the engine can better function to achieve good efficiency and low emissions. Prior to such an engine evolution, the same over the road truck might have had a simple air to air aftercooler that did not need substantial corrosive resistance since there may not have been exhaust gas recirculation. Even where exhaust gas recirculation has been used, typically the exhaust gases were added to the intake downstream from the air cooler. The spatial envelope available for intake gas cooling, however, has remained about the same, leading to the need for a high density corrosive resistant gas to air heat exchanger of a type described in this disclosure.

The gas to air heat exchanger of the present disclosure seeks to address the needs of specific portions of the heat exchanger with materials having specific properties and in specific quantities (wall thicknesses) necessary to perform needed functions. For instance, the air fins need not necessarily be corrosive resistant but should be made from a highly thermally conductive material, such as one predominantly made of copper so that good heat transfer can occur from air fins 66 to air passing through heat exchanger 28. Tubes 67, on the other hand, also need substantial heat exchanging capabilities, but this must be tempered with the need for corrosive resistance, either through selection of suitable tube material, or via the coating strategy described herein. Although air fins 66 can be made extremely thin, tubes 67 generally have a wetted wall thickness thicker than that of air fins 66. The respective heads 69 and 70 attached to opposite ends of tubes 67 should have a thickness at least on the order of that of the tubes and are preferably made of the same materials, for ease in attaching the two during a high temperature brazing process. Core 60 can be completed with a low temperature brazing process when attaching the relatively thin predominantly copper air fins 66 to the outer surfaces of tubes 67. Although tanks 61 and 63 could also be made from stainless steel, substantial cost savings can be achieved by making them from a less expensive material, such as cast aluminum, and possibly a composite for the cooler outlet tank 63. However, because aluminum has less corrosive resistance than stainless steel, the walls of tanks 61 and 63 would generally have to be thicker than that of tubes 67 and head 69 and 70 so that the inevitable corrosion to the wetted inner surface of the tanks could be tolerated over the expected life of the heat exchanger 28 without holes developing. Any problems associated with attaching aluminum and/or composite tanks to the stainless steel heads of core 60 may be remedied via a mechanical attachment process, such as by crimping and extension of the heads about a flange on the respective tank 61 and 63. Before doing so, a suitable o-ring seal is positioned between the tanks and heads to inhibit leakage of corrosive gases from heat exchanger 28. Thus, the present disclosure brings a unique combination of heat exchanger features together, and assembles them in a unique way to arrive at a cost effective heat exchanger that can tolerate corrosive gases, and cool the same in a relatively small spatial volume.

With regard to the embodiment shown in FIG. 5, heat exchangers may be manufactured from particularly effective heat exchange base materials, yet protected from the corrosive environment of hot, acidic condensed exhaust gases. These goals may be achieved without sacrificing weight, increasing complexity or expanding the spatial envelope within which the heat exchanger is positioned in an engine system. In embodiments wherein the tubes are made from predominantly copper, coating the tubes with corrosive resistant brazing material can provide for heat exchangers with a relatively fewer number of conventionally sized and configured tubes than in designs using other tube materials such as stainless steel. Moreover, the ability to attach all or virtually all of the components of a heat exchanger core, while providing a corrosive resistant coating, enables a relatively simple and efficient manufacturing process.

It should be understood that the above description is intended for illustrative purposes only, and is not intended to limit the scope of the present disclosure in any way. Thus, those skilled in the art will appreciate that various modifications might be made to the presently disclosed embodiments without departing from the full and fair spirit and scope of the present disclosure. For instance, while it is contemplated that the heat exchangers described herein are well suited to use in acidic corrosive environments associated with EGR equipped engines, the present disclosure is not thereby limited. Salt water environments may result in corrosion of heat exchanger materials via introduction of salt laden air or water into fluid passages of a heat exchanger. Heat exchanger performance and corrosion resistance may be addressed in such situations in a manner similar to that described herein regarding exhaust gas environments, namely, through the proper selection and placement of heat exchanger materials and/or coating of corrosion sensitive surfaces of the heat exchanger. Further, while air will typically be used as a cooling fluid, some other fluid such as water or engine coolant might be used in the heat exchangers described herein without departing from the full and fair scope of the present disclosure. Other aspects, objects, and advantages of the disclosure can be obtained from a study of the drawings, the disclosure and the appended claims.

What is claimed is:

1. A gas to fluid heat exchanger comprising:
a core having a plurality of tubes in heat transfer contact with a plurality of fins, said tubes being fluidly isolated from said fins;
a plurality of turbulators disposed within said tubes and comprising at least one base material having a relatively low corrosive resistance; and
a brazing material having a relatively high corrosive resistance coating said turbulators and attaching said turbulators to said tubes.

2. The gas to fluid heat exchanger of claim 1 comprising first and second heads connected to said tubes via said brazing material.

3. The gas to fluid heat exchanger of claim 1 wherein said brazing material has a relatively high acidic corrosive resistance relative to an acidic corrosive resistance of said at least one base material.

4. The gas to fluid heat exchanger of claim 3 wherein said heat exchanger comprises a charge air cooler for a turbocharged internal combustion engine, wherein said at least one base material is predominantly copper, said brazing material comprising a copper compatible brazing material, and wherein said tubes are attached to said air fins via said brazing material.

5. The gas to fluid heat exchanger of claim 4 wherein said tubes comprise a primary heat transfer surface of said heat exchanger, said brazing material coating said heat transfer surface.

6. The gas to fluid heat exchanger of claim 5 wherein said tubes comprise predominantly copper.

7. The gas to fluid heat exchanger of claim 4 wherein said tubes comprise predominantly stainless steel.

8. An engine system comprising:
an engine housing;
a gas passage fluidly connected to said engine housing; and
a gas to fluid heat exchanger fluidly positioned within said gas passage, said gas to fluid heat exchanger comprising, a core having a plurality of tubes and a plurality of fins in heat transfer contact with said tubes, and a plurality of turbulators disposed within said tubes, said turbulators comprising at least one base material having a relatively low corrosive resistance and being coated with a brazing material having a relatively high corrosive resistance which attaches said turbulators to said tubes.

9. The engine system of claim 8 further comprising a compressor and an engine intake fluidly connecting with said gas passage, said gas to fluid heat exchanger comprising a gas to air heat exchanger fluidly positioned between said compressor and said engine intake.

10. The engine system of claim 10 further comprising an exhaust gas return loop fluidly connected to said engine housing and said gas passage, and a cooling air passage configured to direct cooling air past said fins.

11. The engine system of claim 10 wherein the at least one base material of said turbulators comprises a first thickness, said brazing material comprising a second thickness that is less than said first thickness.

12. The engine system of claim 11 wherein the second thickness is in the range of about 0.05 millimeters to about 0.10 millimeters.

13. The engine system of claim 11 wherein at least one base material comprises predominantly copper.

14. A method of making a gas to air heat exchanger comprising the steps of:
coating at least one base material of a turbulator having a relatively low corrosive resistance with a brazing material having a relatively high corrosive resistance;
placing the turbulator within a tube of a heat exchanger core; and
attaching the turbulator to the tube at least in part via the brazing material.

15. The method of claim 14 wherein:
the coating step comprises applying a brazing material to heat exchange surfaces of a plurality of turbulators;
the placing step comprises placing the plurality of turbulators within a plurality of tubes of the heat exchanger core; and
the attaching step comprises attaching the turbulators to the tubes at least in part via a step of heating the turbulators and tubes together in a brazing furnace.

16. The method of claim 15 wherein the coating step comprises coating heat exchange surfaces of the turbulators with a fluent brazing material prior to the attaching step.

17. The method of claim 16 further comprising a step of coating heat exchange surfaces of the tubes with the brazing material.

18. The method of claim 16 further comprising a step of positioning a plurality of air fins comprising an air fin material having a relatively lower corrosive resistance than the brazing material in thermal contact with the tubes.

19. The method of claim 18 further comprising a step of attaching the plurality of air fins to the tubes with brazing material at least in part via the heating step.
